(19) United States
(12) Patent Application Publication
(10) Pub. No.: US 2016/0028687 A1
(43) Pub. Date: Jan. 28, 2016

(54) Internet Security Assembly

(71) Applicant: David Sheppard, Venice, FL (US)

(72) Inventor: David Sheppard, Venice, FL (US)

(21) Appl. No.: 14/340,806

(22) Filed: Jul. 25, 2014

(51) Int. Cl. H04L 29/06

(52) U.S. Cl. CPC H04L 63/02; H04L 63/145; H04L 63/20

(57) ABSTRACT

An internet security assembly includes a firewall computer. The firewall computer comprises a housing. A processor is coupled to the housing. An input is coupled to the housing, the processor and a modem. The input receives an internet signal from the modem. An electronic memory is coupled to the housing and the processor. The electronic memory contains a firewall protection program. The firewall protection program identifies and removes malware in the internet signal. An output is coupled to the housing and the processor. The output receives the internet signal after the malware is removed. The output is operationally coupled to a plurality of external computers. The plurality of external computers receives the internet signal. A transceiver is coupled to the housing and the processor. The transceiver receives the internet signal after the malware is removed from the internet signal. The transceiver is in communication with the plurality of external computers.

### BACKGROUND OF THE DISCLOSURE

### Field of the Disclosure

The disclosure relates to security devices and more particularly pertains to a new security device for detecting and removing malware from an internet signal in a local area network.

### SUMMARY OF THE DISCLOSURE

An embodiment of the disclosure meets the needs presented above by generally comprising a firewall computer in communication with a plurality of external computers. The firewall computer comprises a housing. A processor is coupled to the housing. An input is coupled to the housing. The input is operationally coupled to the processor. The input is in communication with a modem. The input receives an internet signal from the modem. An electronic memory is coupled to the housing. The electronic memory is operationally coupled to the processor. The electronic memory contains a firewall protection program. The firewall protection program identifies and removes malware in the internet signal. An output is coupled to the housing. The output is operationally coupled to the processor. The output receives the internet signal after the malware is removed from the internet signal. The output is operationally coupled to the plurality of external computers. The plurality of external computers receives the internet signal. A transceiver is coupled to the housing. The transceiver is operationally coupled to the processor. The transceiver receives the internet signal after the malware is removed from the internet signal. The transceiver is in communication with the plurality of external computers.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front view of a internet security assembly according to an embodiment of the disclosure.

FIG. 2 is a top view of an embodiment of the disclosure.

FIG. 3 is a back view of an embodiment of the disclosure.

FIG. 4 is a schematic view of an embodiment of the disclosure.

FIG. 5 is a logic tree view of an embodiment of the disclosure.

### DESCRIPTION OF THE PREFERRED EMBODIMENT

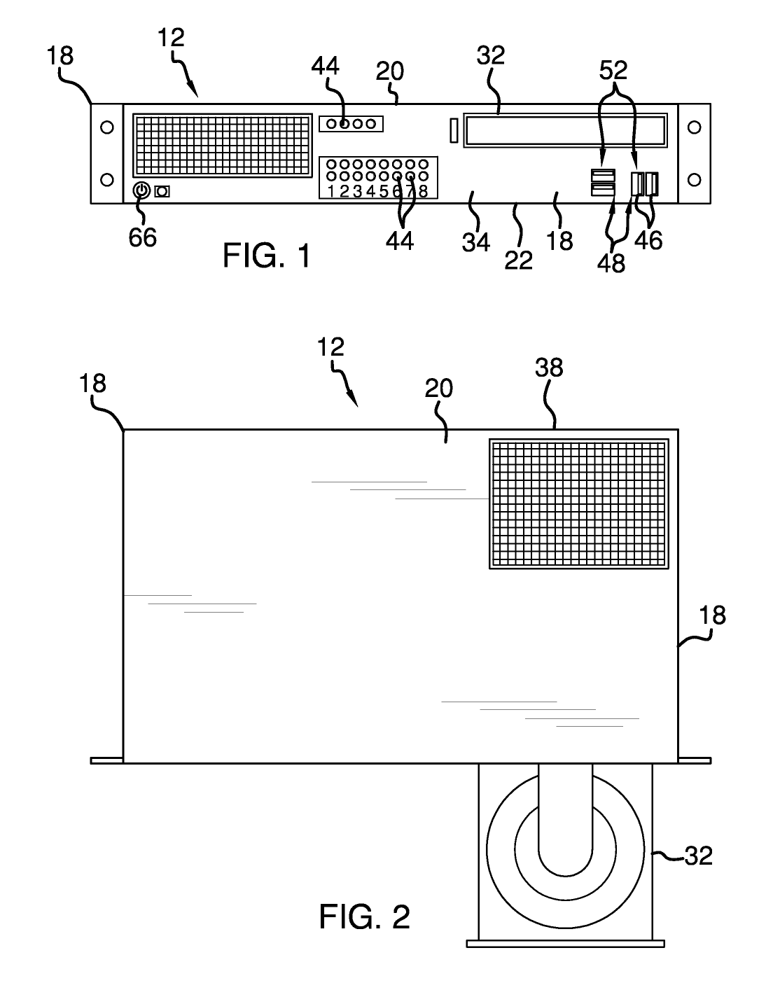

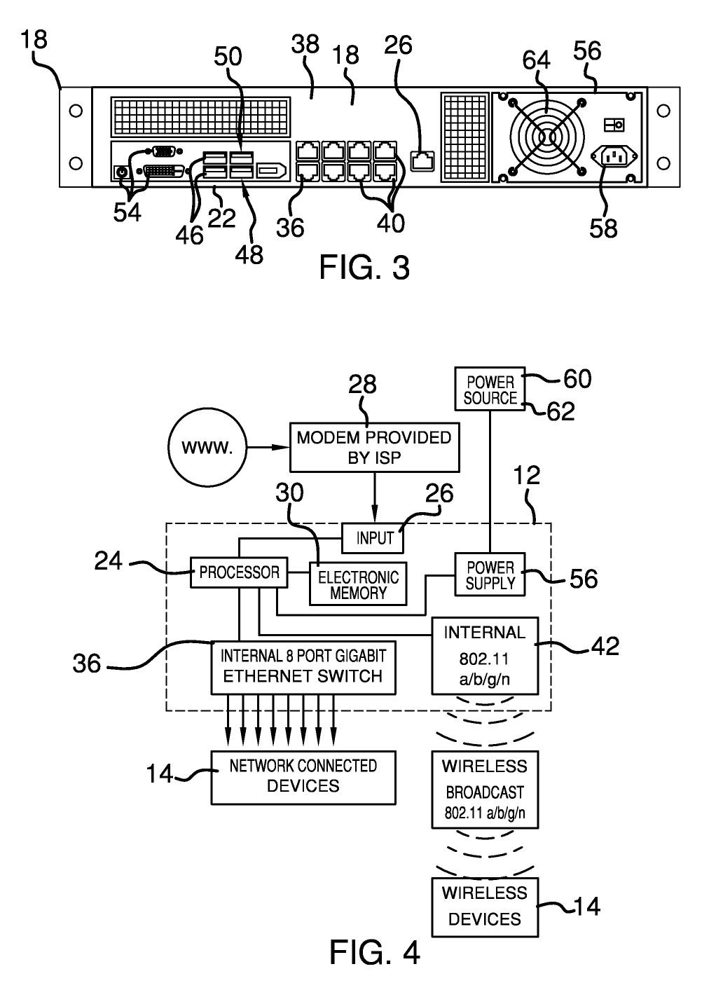

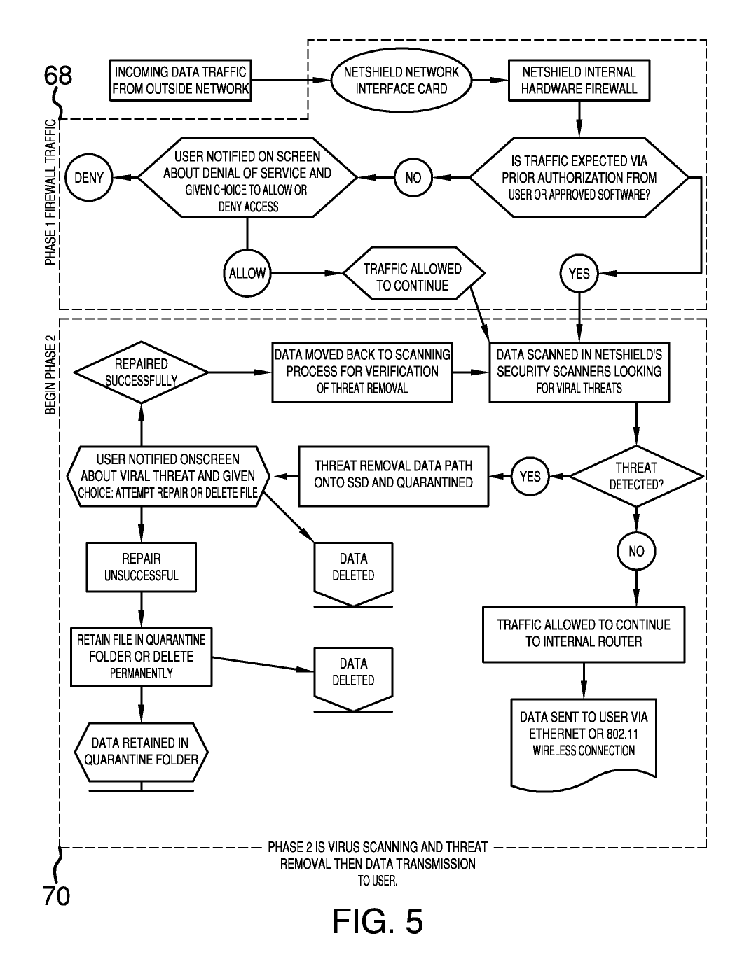

With reference now to the drawings, and in particular to FIGS. 1 through 5 thereof, a new security device embodying the principles and concepts of an embodiment of the disclosure and generally designated by the reference numeral 10 will be described.

As best illustrated in FIGS. 1 through 5, the internet security assembly 10 generally comprises a firewall computer 12 in communication with a plurality of external computers 14. The plurality of external computers 14 may be personal computers of any conventional design. The firewall computer 12 comprises a housing 16. The housing 16 has an outer wall 18 extending between a top wall 20 and a bottom wall 22 of the housing 16.

A processor 24 is coupled to the housing 16. The processor 24 may be a computer processor of any conventional design. An input 26 is coupled a back side 38 of the outer wall 18 of the housing 16. The input 26 is electrically coupled to the processor 24.

The input 26 is in electromagnetic communication with a modem 28. The input 26 receives an internet signal from the modem 28. The input 26 may be an Ethernet port of any conventional design. The modem 28 may be a modem of any conventional design.

An electronic memory 30 is coupled to the housing 16. The electronic memory 30 is electrically coupled to the processor 24. Additionally, the electronic memory 30 contains a firewall protection program. The firewall protection program identifies and removes malware in the internet signal. The electronic memory may be a hard drive of any conventional design.

An optical drive 32 is coupled to a front side 34 of the outer wall 18 of the housing 16. The optical drive 32 is electrically coupled to the processor 24. The optical drive 32 reads data from an optical storage disk. The optical drive 32 may be a CD/DVD drive of any conventional design.

An output 36 is coupled to the back side 38 of the outer wall 18 of the housing 16. The output 36 is electrically coupled to the processor 24. The output 36 receives the internet signal after the malware is removed from the internet signal. Additionally, the output 36 may be a gigabit Ethernet switch of any conventional design. The output 36 is one of a plurality of outputs 40 each electrically coupled to an associated one of the plurality of external computers 14. The plurality of external computers 14 receives the internet signal.

A transceiver 42 is coupled to the housing 16. The transceiver 42 is electrically coupled to the processor 24. The transceiver 42 receives the internet signal after the malware is removed from the internet signal. Additionally, the transceiver 42 is in electromagnetic communication with the plurality of external computers 14.

The transceiver 42 may utilize a WPAN signal. Additionally, the transceiver 42 may be an 802.11 a/b/g/n RF transceiver of any conventional design. The plurality of external computers 14 may be either electrically coupled to the output 36 or placed in electromagnetic communication with the transceiver 42. The plurality of external computers 14 may additionally define a local area network.

A plurality of light emitters 44 is coupled to the front side 34 of the outer wall 18 of the housing 16. The plurality of light emitters 44 is electrically coupled to the processor 24. Each of the plurality of light emitter 44 emits light when the output 36 relays the internet signal to the plurality of external computers 14.

A plurality of data ports 46 is coupled to the housing 16. The plurality of data ports 46 is electrically coupled to the processor 24. Additionally, the plurality of data ports 46 comprise a pair of sets 48 of the data ports 46. A first one 50 of the pair of sets 48 of the data ports 46 is coupled to the back side 38 of the outer wall 18 of the housing 16. A second one 52 of the pair of sets 48 of the data ports 46 is coupled to the front side 34 of the outer wall 18 of the housing 16. The plurality of data ports 46 may comprise a USB data port of any conventional design.

A plurality of video ports 54 is coupled to the back side 38 of the outer wall 18 of the housing 16. The plurality of video ports 54 is electrically coupled to the processor 24. Each of the plurality of video ports 54 delivers a video signal of any conventional design.

A power supply 56 is coupled to the housing 16. The power supply 56 is electrically coupled to the processor 24. The power supply 56 includes a power port 58 coupled to the back side 38 of the outer wall 18 of the housing 16. The power port 58 is electrically coupled to a power source 60. The power source 60 may be an electrical outlet 62 of any conventional design.

A fan 64 is coupled to the back side 38 of the outer wall 18 of the housing 16. The fan 64 is electrically coupled to the power supply 56. The fan 64 cools the processor 24, the output 36 and the transceiver 42. An actuator 66 is coupled to the front side 34 of the outer wall 18 of the housing 16. The actuator 66 is electrically coupled to the power supply 56. The actuator 66 selectively actuates and de-actuates the power supply 56.

The firewall computer 12 examines the internet signal in a first phase 68 of firewall protection. The first phase 68 identifies if the internet data traffic originates from a previously authorized source. Permission must be granted for the internet signal to be utilized if the internet signal originates from an un-authorized source.

The firewall computer routes the internet signal to a second phase 70 of firewall protection. The internet data traffic is scanned for malware. The internet data traffic is routed to a quarantine path if malware is detected in the internet data traffic. Additionally, the internet data traffic is routed to the output 36 and the transceiver 42 if no malware is detected. The quarantine path attempts to either repair the internet data signal with respect to the malware or the internet data signal is permanently deleted from the electronic memory 30.

In use, the firewall computer 12 is installed in the local area network. The firewall computer 12 performs malware protection for the plurality of external computers 14. A performance of the plurality of external computers 12 is increased due to the firewall protection being accomplished by the firewall computer 14. The plurality of external computers 14 do not need to scan the internet data signal for malware.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An internet security assembly comprising:
a firewall computer in communication with a plurality of external computers, said firewall computer comprising
a housing;
a processor coupled to said housing;
an input coupled to said housing, said input being operationally coupled to said processor, said input being in communication with a modem such that said input receives an internet signal from the modem;
an electronic memory coupled to said housing, said electronic memory being operationally coupled to said processor, said electronic memory containing a firewall protection program such that the firewall protection program identifies and removes malware in the internet signal;
an output coupled to said housing, said output being operationally coupled to said processor such that said output receives the internet signal after the malware is removed from the internet signal, said output being operationally coupled to the plurality of external computers such that the plurality of external computers receives the internet signal; and
a transceiver coupled to said housing, said transceiver being operationally coupled to said processor such that said transceiver receives the internet signal after the malware is removed from the internet signal, said transceiver being in communication with the plurality of external computers.

2. The internet security assembly according to claim 1, further comprising said input being electrically coupled to said processor, said input being in electromagnetic communication with the modem.

3. The internet security assembly according to claim 1, further comprising said electronic memory being electrically coupled to said processor.

4. The internet security assembly according to claim 1, further comprising said housing having an outer wall extending between a top wall and a bottom wall of said housing.

5. The internet security assembly according to claim 4, further comprising said output being coupled to a back side of said outer wall of said housing, said output being electrically coupled to said processor, said output being one of a plurality of outputs each electrically coupled to an associated one of the plurality of external computers.

6. The internet security assembly according to claim 1, further comprising said transceiver being electrically coupled to said processor, said transceiver being in electromagnetic communication with the plurality of external computes.

7. The internet security assembly according to claim 1, further comprising a power supply coupled to said housing.

8. The internet security assembly according to claim 7, further comprising said power supply being electrically coupled to said processor.

9. The internet security assembly according to claim 8, further comprising said power supply including a power port coupled to a back side of an outer wall of said housing.

10. The internet security assembly according to claim 9, further comprising said power port being electrically coupled to a power source.

11. The internet security assembly according to claim 1, further comprising an actuator coupled to a front side of an outer wall of said housing.

12. The internet security assembly according to claim 11, further comprising said actuator being electrically coupled to a power supply such that said actuator selectively actuates and de-actuates said power supply

13. An internet security assembly comprising:
a firewall computer in communication with a plurality of external computers, said firewall computer comprising;
a housing having an outer wall extending between a top wall and a bottom wall of said housing;
a processor coupled to said housing;
an input coupled to said housing, said input being electrically coupled to said processor, said input being in electromagnetic communication with a modem such that said input receives an internet signal from the modem;
an electronic memory coupled to said housing, said electronic memory being electrically coupled to said processor, said electronic memory containing a firewall protection program such that the firewall protection program identifies and removes malware in the internet signal;
an output coupled to a back side of said outer wall of said housing, said output being electrically coupled to said processor such that said output receives the internet signal after the malware is removed from the internet signal;
said output being one of a plurality of outputs each electrically coupled to an associated one of the plurality of external computers such that the plurality of external computers receives the internet signal;
a transceiver coupled to said housing, said transceiver being electrically coupled to said processor such that said transceiver receives the internet signal after the malware is removed from the internet signal, said transceiver being in electromagnetic communication with the plurality of external computers;
a power supply coupled to said housing, said power supply being electrically coupled to said processor, said power supply including a power port coupled to said back side of said outer wall of said housing, said power port being electrically coupled to a power source; and
an actuator coupled to a front side of said outer wall of said housing, said actuator being electrically coupled to said power supply such that said actuator selectively actuates and de-actuates said power supply
